(19) United States
(12) Patent Application Publication
(10) Pub. No.: US 2006/0122944 A1
(43) Pub. Date: Jun. 8, 2006

(54) Methods and systems for enabling communication to and from asset tracking devices

(76) Inventors: Philip J. Ryan, Stanmore (AU); Geoffrey J. Smith, Brisbane (AU)

Correspondence Address: RAYMOND J. WERNER, 2056 NW ALOCLEK DRIVE, SUITE 314, HILLSBORO, OR, 97124, US

(21) Appl. No.: 11/186,081

(22) Filed: Jul. 20, 2005

Related U.S. Application Data
(60) Provisional application No. 60/589,394, filed on Jul. 20, 2004.

(51) Int. Cl. G06Q 99/00

(52) U.S. Cl. 705/67

(57) ABSTRACT

Methods and systems for enabling communication include a third party wireless access point and authorization mechanism that forwards messages between an asset tracking device and a remote tracking entity based, at least in part, upon whether an outbound message contains a destination address that is on an approved list maintained by the authorization mechanism, and upon whether an inbound message contains a source address that is on an approved list maintained by the authorization mechanism. In further aspects of the present invention, error handling is provided for circumstances in which the destination or source addresses are not on the approved list maintained by the authorization mechanism.

### RELATED APPLICATIONS

This application claims the benefit of earlier filed U.S. provisional application 60/589,394, which was filed Jul. 20, 2004, and the entirety of which is hereby incorporated by reference.

### FIELD OF THE INVENTION

The present invention relates to methods and systems for enabling communication. More particularly, the present invention relates to methods and systems for enabling communication between an asset tracking device and a reporting server via a third party access point.

### BACKGROUND

A major focus of companies today is the security and visibility of inventory assets throughout the supply chain. This is particularly important when the management, processing, or delivery of a high value asset is outsourced to another company. The use of Radio Frequency Identification (RFID) tags to facilitate item tracking is well known.

RFID tags are electronic devices that generally comprise a passive transponder and an integrated circuit programmed with unique identification information. In the context of a supply chain, they are located on items and pallets of items, and may be used as a replacement for barcodes to identify such items and/or pallets.

An RFID tag reader is used to read the data programmed on the RFID tag. An RFID tag reader typically includes an antenna, a transceiver, and a decoder, and can be configured either as a handheld unit or as a fixed-mount device. The tag reader emits radio waves in ranges of anywhere from a few centimeters to about 40 meters, depending on the tag reader's power output and the radio frequency used. When an RFID tag passes through the tag reader's electromagnetic zone, it detects the tag reader's activation signal. This signal energizes the RFID tag and enables the tag to transmit the data stored, or otherwise encoded, on its integrated circuit to the tag reader. The tag reader decodes this data and the data is typically passed to a host computer for further processing.

RFID tags are generally passive tags in that they have no internal power source and rely on an external source to provide power. In some instances, RFID tags may be active, in that they have an internal power source. Active RFID tags are more expensive and bulkier than passive RFID tags and, as such, are generally not the preferred tracking device for item level tracking.

Due to memory and processor limitations, the data stored on the RFID tag is generally little more than a unique identifier for the item. Hence, conventional systems offer little more than an electronic bar code that can be read from moderate distances.

A further disadvantage of conventional RFID tracking systems is the lack of synchronicity and integrity of the data across an entire supply chain. As different entities become involved in subsequent phases of the supply chain, the effective tracking of items from source to destination becomes complex and expensive. The integration of a company's backend systems with transport contractors and the like to enable auditing and tracking of a company's items throughout the supply chain is difficult and not scaleable.

For example, consider the situation where a transport contractor is used by a wide variety of companies to move freight. Each company has their own RFID system and the transport contractor has their own RFID system. While the transport company can read the data on the RFID tags for each company, the integration of the transport contractor's backend computer system with that of each company is difficult and expensive and hence the companies have difficulty in reliably tracking their products throughout the supply chain.

More sophisticated tags have been developed whereby these tags have wireless communication capabilities, position determination capabilities and environmental sensing capabilities. These tags are able to send information to a tracking entity via the Internet. However, there exists significant security and connection problems with this solution resulting from the fact that the access points which these tags use to communicate with the tracking server are generally not operated by the same party that owns the tags.

For example, a supplier owns assets moving through the supply chain and also owns the sophisticated location tags that are located on the assets. However, when the assets are located in a warehouse owned by a transport company, for example, the location tags rely on the warehouse's network access point to communicate with the supplier's tracking server over the Internet. The proprietor of the warehouse administers the warehouse network access point.

A significant problem in this situation is the authentication of the location tags by the warehouse network access point. One solution is to ensure that all the sophisticated location tags store credentials that will be accepted by the warehouse's network. Hence, all the sophisticated location tags will transmit authentication information to the warehouse's access point in order to forward reporting details to the tracking entity over the Internet. The warehouses network will validate each tag's network access request upon receipt and authenticate the tags credentials before granting network access.

However, this solution is clearly not scaleable in that there may be millions of distinct tags passing through the warehouse in a year and it would be necessary to alert the warehouse's network of the access credentials of each of these tags in order that each of these tags may communicate with the tracking server. This problem is further compounded if the sophisticated tracking tags pass through a warehouse or the like that does not have each of the tags' access credentials. Hence, this solution does not support pervasive tracking that is necessary in total supply chain management.

An alternative solution is to allow all communication requests received by the warehouses' network access point. While this solution is scaleable in that there is no authentication required for the sophisticated tags to communicate with a tracking server via a third party access point, there exist serious security issues. As the warehouse is in effect allowing unfettered access to the Internet via its access point, it consequently allows unrestricted access to its internal network. In the situation where the access point is a wireless access point, any person with a wireless-enabled computing device within range of the access point may have unrestricted access to the Internet and, more significantly, to the internal network of the warehouse. This clearly is an undesirable solution.

Hence, it is desirable to develop a more secure and scaleable communication method for tracking entities, such as sophisticated location tags, communicating with a tracking entity via a third party access point.

Furthermore, it is desirable that communication between each sophisticated tag and the tracking entity is secure such that the network access provider, for example the warehouse's network, is not able to eavesdrop on the data packets that are travelling between the sophisticated location tag and the tracking entity via its network access point.

What is needed are methods and systems adapted to securely and cost-effectively provide communication between an asset tracking device and a remote tracking entity through an access point and network of a third party.

### SUMMARY OF THE INVENTION

Briefly, methods and systems for enabling communication include a third party wireless access point and authorization mechanism that forwards messages between an asset tracking device and a remote tracking entity based, at least in part, upon whether an outbound message contains a destination address that is on an approved list maintained by the authorization mechanism, and upon whether an inbound message contains a source address that is on an approved list maintained by the authorization mechanism.

In further aspects of the present invention, error handling is provided for circumstances in which the destination or source addresses are not on the approved list maintained by the authorization mechanism.

### BRIEF DESCRIPTION OF THE DRAWINGS

FIG. 1 is a block diagram showing a system for enabling communication in accordance with the present invention.

FIG. 2 is a flow diagram showing a method of enabling communication in accordance with the present invention.

### DETAILED DESCRIPTION

Generally, the present invention provides for communication between an asset tracking device and a remote tracking entity through a third party wireless access point and authorization mechanism. In various embodiments of the present invention the authorization mechanism involves determining whether a message from an asset tracking device is targeted for a destination having an address that is known to the authorization mechanism as an approved destination. Similarly, the authorization mechanism may approve or reject incoming messages for an asset tracking device based on whether the source address of the incoming message is known to the authorization mechanism.

In one form, although it need not be the only or indeed the broadest form, the invention provides a method of enabling communication between a device and a tracking entity via a network access point, the method including:

(a) communicating a data packet from the device to the network access point, the data packet having a header including a destination network address of the tracking entity;

(b) communicating the data packet from the network access point to an authorization entity; and

(c) determining whether the destination network address is a trusted network address and, if so, communicating the data packet from the authorization entity to the destination network access address of the tracking entity.

In step (c) of some embodiments of the present invention, the authorization entity queries a trusted address data store to determine whether the destination network address is trusted.

In some embodiments, the device, the network access point and the authorization entity are located at a location geographically separate from the tracking entity. The communication between the network access point and the authorization entity occurring over a local network of the location.

In alternative embodiments, the authorization entity forms part of the network access point.

In some embodiments, the communication between the network access point and the authorization entity occurs over the Internet, whereas in other embodiments this communication is over a local area network.

In some embodiments, the device is an asset tracking-device located on an asset and the tracking entity has an interest in the asset.

In a further form, the invention provides-a method of communicating a data packet from a device to a tracking entity via a network access point, the network access point having access to a trusted network address data store, the trusted network address data store having a list of trusted network addresses, the method including:

communicating a data packet from the device to the network access point, the data packet having a header including a trusted network address of the tracking entity.

In yet a further form, the invention provides a method of receiving a data packet at a network access point from a device, the data packet having a header including a destination network address of the tracking entity, the method including:

receiving the data packet at the network access point;

determining whether the network address is a trusted network address by communicating the destination network address of the entity to an authorization server; and

if the destination address of the entity is trusted, communicating the data packet to the destination network address of the tracking entity.

In still a further form, the invention provides a system for enabling communication, the system comprising:

a device having communication means to communicate a data packet to a network access point, the data packet having a header including a network address of a first entity;

the network access point having a communication means to receive the data packet communicated from the device and to communicate the data packet to an authorization entity; and

the authorization entity having a communication means for communicating with the network access point, the communication means also communicating with a trusted network address store to determine whether the network address of the first entity is located in a storage means of the trusted network address data store;

wherein if the network address of the first entity is located within the storage means of the trusted network address data store, the authorization entity communicates the data packet to the network address of the first entity.

Reference herein to “one embodiment”, “an embodiment”, “some embodiments”, or similar formulations, means that a particular feature, structure, operation, or characteristic described in connection with the embodiment, is included in at least one embodiment of the present invention. Thus, the appearances of such phrases or formulations herein are not necessarily all referring to the same embodiment. Furthermore, various particular features, structures, operations, or characteristics may be combined in any suitable manner in one or more embodiments.

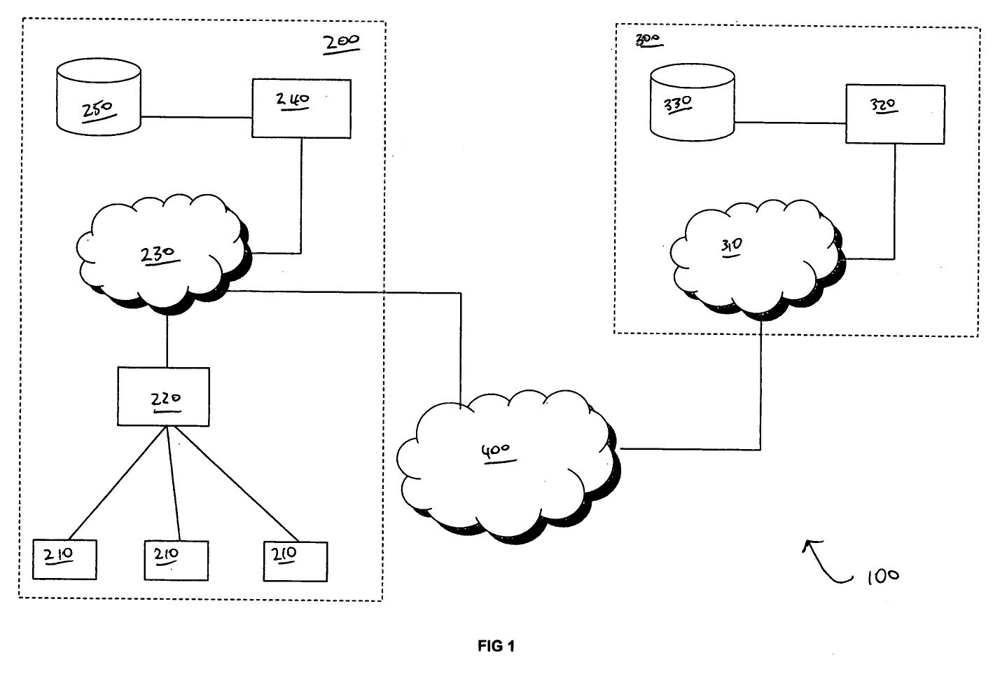

FIG. 1 shows a system for enabling communication 100 in accordance with the present invention. System 100 comprises a location 200 and a tracking entity 300 in communication via a public network in the form of the Internet 400. In some embodiments, location 200 is a warehouse that is geographically separated from tracking entity 300.

Location 200 has a plurality of asset tracking devices 210, a network access point 220, an internal communication network 230, such as, for example, a local area network, a communication authorization entity 240 and a trusted address data store 250.

Each asset tracking device 210 is located on an asset to be tracked (not shown) and may include sensor modules (not shown) to determine environmental conditions, a location determination module (not shown), and a communication module (not shown). Each asset tracking device 210 is in communication with network access point 220.

In some embodiments, network access point 220 is in the form of a wireless access point as is known in the art. Hence, communication between each asset tracking device 210 and network access point 220 is via wireless communication.

Network access point 220 is in communication with internal communication network 230 of location 200. Internal communication network 230 is a private network and may be in the form of any local network known in the art. Internal communication network 230 is in communication with the Internet 400 with all communication between entities forming part of the internal network 230 and the Internet 400 being restricted based on security protocols known in the art implemented on the internal network 230.

A communication authorization entity, in the form of an authorization server 240, is in communication with internal network 230. The function of the authorization server 240 is described in greater detail below.

A trusted address data store 250 is in communication with authorization server 240. In some embodiments, trusted address data store 250 is in the form of a database, such as a relational database, having a list of trusted IP addresses.

It will be appreciated that although for this illustrative embodiment, location 200 is described in the context of a warehouse, location 200 may be any form of third party storage or transport location wherein access point 220 and internal network 230 are administered by an entity that does not own the assets upon which asset tracking devices 210 are located. For example, location 200 may be a container ship, and one or more asset tracking devices 210 may be located on each shipping container on the ship.

Still referring to FIG. 1, tracking entity 300 has an internal private network 310, a reporting server 320 in communication with private network 310 and an asset tracking device data store 330 in communication with reporting server 320. Private network 310 of tracking entity 300 is in communication with Internet 400 and may be of the form of any known type of local area network.

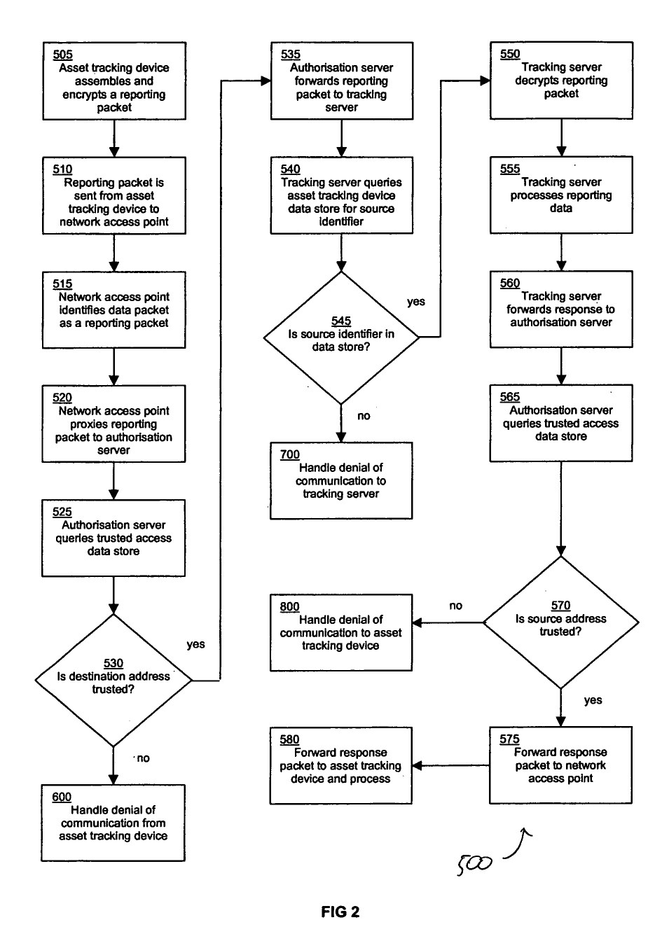

Tracking entity 300 has an interest in communicating with one or more of asset tracking devices 210. In some embodiments, tracking entity 300 owns the assets upon which asset tracking devices 210 are located. The function of the components of tracking entity 300 are described in greater detail below in conjunction with the flow diagram of FIG. 2.

The present invention provides for communication between one or more asset tracking devices 210 and tracking entity 300 whereby each asset tracking device 210 is able to use network access point 220 to communicate with tracking entity 300 without any form of authentication of asset tracking device 210 taking place. In effect, each message is authenticated rather than the source of the message (i.e., asset tracking device 210).

FIG. 2 is a flow diagram showing a method 500 of enabling communication between each asset tracking device 210 and tracking entity 300 via third party network access point 220.

Method 500 commences when an asset tracking device 210 wishes to send a reporting data packet to tracking entity 300. Asset tracking device 210 assembles and encrypts the reporting packet (505).

In some embodiments, the reporting packet has a header and reporting data. The header, in accordance with the present invention, includes an indicator identifying that the current data packet is a reporting packet, a source identifier and a destination address. Typically, the source identifier is a unique identifier associated with a particular asset tracking device 210 and is hard wired into the device when asset tracking device 210 is created. Alternatively, the asset tracking identifier may be stored in memory located on asset-tracking device 210 and may be changeable. In this illustrative embodiment, the destination address is the IP address of tracking entity 300, which has an interest in the asset upon which asset tracking device 210 is located. This destination address is typically stored in a memory of asset tracking device 210 prior to asset tracking device 210 being disposed upon an asset to be tracked. Typically, the IP address of tracking entity 300 only is stored in the memory of asset tracking device 210. Alternatively, one more asset tracking devices 210 may have a plurality of destination addresses stored therein, and, in operation, select which destination to send a reporting packet to based on differing reporting events.

The reporting data information may include the clock value of asset tracking device 210, a GPS location of asset tracking device 210, sensor information determined by a variety of environmental modules located on, or in communication with, asset tracking device 210, and similar information. Additionally, the reporting data may include information relating to data of other asset tracking devices 210, within range of a radio frequency receiver module located on the asset tracking device. It will be appreciated that other information may be included in the data payload of the reporting data packet.

The reporting packet is generated in response to certain events as programmed in asset tracking device 210. For example, asset tracking device 210 may send reporting data at pre-determined time intervals, or when the asset tracking device receives a reading on one of its sensor modules that is outside predetermined limits.

The reporting packet is transmitted to network access point 220 of location 200 via a wireless communication pathway (510). It will be appreciated that the reporting packet will be wrapped in an appropriate wireless communication data packet in order to support this mode of communication.

Network access point 220 receives the transmitted data packet and identifies from the reporting data packet header that the received data is a reporting data packet in accordance with the present invention (515). The network access point 220 then forwards this reporting packet over local area network 230 of location 200 to authorization server 240 (520).

Authorization server 220 reads the destination address from the header of the reporting packet and queries trusted address data store 250 (525) to determine whether the destination address is located in the trusted address data store (530). Trusted data store 250 contains a list of IP addresses, or host names, to which data packets may be sent.

If the destination address read from the reporting packet is not located in trusted address data store 250, then the authorization server refuses to forward the data packet to the destination address and forwards a rejection message to asset tracking device 210 (600). In some embodiments, this rejection message contains an indication to asset tracking device 210 as to why the reporting data packet has not been sent to the requested destination. In such embodiments, asset tracking device 210 may handle the rejection message in accordance with predetermined programming or hardwired circuits contained therein. Alternatively, no rejection message will be sent, and authentication server 240 will drop the refused reporting data packet.

If the destination address from the reporting data packet is located by the authorization server 240 in the trusted address data store 250, then authorization server 240 communicates the reporting data packet to tracking server 320 of the tracking entity 300 (535). Hence, the message will pass from the authentication server 230, over the Internet 400 to local area network 310 of tracking entity 300 and then to tracking server 320.

Tracking server 320 reads the source identifier from the reporting data packet and queries asset tracking data store 320 (540) to determine whether that unique identifier is located in asset tracking data store 320 (545).

Asset tracking data store 330 contains a list of unique identifiers for all asset tracking devices 210 managed by tracking entity 300. In this illustrative embodiment, asset tracking data store 330 also contains information associated with each asset tracking device 210 managed by tracking entity 300.

If tracking server 320 does not locate the source identifier for the sending asset tracking device 210, then tracking server 320 generates a rejection data packet that provides details as to the nature of the rejection. Tracking server 320 then forwards the rejection data packet back to authorization server 240 of location 200. This packet is then forwarded from authorization server 240 back to asset tracking device 210 which handles the error packet appropriately (700). Alternatively, tracking server 320 may simply drop the received reporting packet.

If tracking server 320 locates the source identifier of asset tracking device 210 in asset tracking data store 330, then tracking server 320 decrypts the reporting data in the reporting data packet (550) and processes this data (555). In some embodiments, information from the data packet is associated with the asset tracking device's unique identifier and stored.

Tracking server 320 then replies to the reporting data packet received from asset tracking device 210 (560). Tracking server 320 prepares a control data packet that has a header and encrypted data. The header includes an identifier that indicates that the packet is a control packet that conforms to the present invention, the unique identifier of asset tracking device 210 to which the control packet should be sent and the source address of tracking entity 300. The encrypted data in the control packet contains at least an acknowledgement that the reporting packet has been received by tracking entity 300.

In some embodiments, the encrypted data of the control packet may contain information used to alter certain settings in the destination asset tracking device 210. The control packet is then forwarded to authorization server 240 of location 200. The network address of the authorization server is derived from the TCP/IP data packet which is wrapped around the reporting data packet communicated from authorization server 240 to tracking server 322 (560).

Authorization server 240 then queries (565) trusted address data store 250 to determine (570) whether the IP address of the source, as determined by the header wrapped around the control data packet, is a trusted address. If it is not, the data packet is dropped (800). If it is a trusted address, then the control packet is forwarded to the network access point 220 (575) and communicated to asset tracking device 210 for decryption and processing (580).

In an alternative embodiment, the authorization server may forward the control packet to network access point 220 for communication to asset tracking device 210 without determining whether the source address is a trusted address. This is left to asset tracking device 210 to determine whether the source address is on the list of IP addresses of tracking entities 210 stored on asset tracking device 210.

Asset tracking device 210 has thus received confirmation that the reporting data packet sent at 510 has reached tracking entity 300. Additionally, the control packet received by asset tracking device 210 from tracking entity 300 may contain control information, as described above, which requires processing by asset tracking device 210.

Hence, the methods and systems of the present invention provide for a method of communication between an asset tracking device and a tracking entity via a third party network access point without requiring authentication of asset tracking device 210 with network access point 220. Rather, communication of data packets received from each asset tracking device are authorized by the authorization server and communicated to the destination address. Hence, the method of the present invention provides for communication with a finite number of entities having trusted, pre-determined network addresses which are stored in a trusted address data store.

Importantly, the method of the present invention does not provide unrestricted access to the Internet, nor does it provide access to the internal network of the location. Rather, it provides for a mechanism whereby a certain type of data packet may be communicated from an asset tracking device to one or more of a predetermined number of IP addresses and vice versa.

It will be appreciated that at any given location, there may be asset tracking devices that are owned by a plurality of distinct tracking entities. Hence, different asset tracking devices at a given location may be in communication, via the Internet, with different tracking entities at a given time. Furthermore, each tracking entity may have assets at a plurality of locations and hence be in communication, via the internet, with asset tracking devices at a plurality of locations at a given time.

Furthermore, authorization server 240 of FIG. 2 may form part of the network access point 220. Hence, in this embodiment, the network access point 220 may forward approved data packets directly to the destination tracking entity.

Alternatively, authorization server 240 and trusted address data store 250 may be located geographically separate from location 200 and be in communication with network access point 220 via Internet 400. Hence, all reporting packets received from an asset tracking device 210 at a network access point 220 are communicated over the Internet to the network address of authorization server 240 only. The authorization server then determines whether to communicate the data packets to the destination tracking entity or to reject the communication request as described above. In this way, all communication from the asset tracking devices to the respective tracking entities passes through the authorization server.

Optionally, tracking entity 300 caches control messages that are to be sent to an asset tracking device 210.. When tracking entity 300 receives a reporting message from asset tracking device 210, the cached control messages are sent to the network address of location 200 from which the reporting message of the asset tracking device is sent. The control messages are then communicated to asset tracking device 210 at location 200 as described above.

Furthermore, the network access point may communicate all messages to tracking entity 300 received from an asset tracking device 210 without querying trusted data store 250 providing that an initial reporting message received from an asset tracking device has been authenticated. A configurable time out may be set to define a time limit for this form of communication.

### CONCLUSION

Described herein are methods and systems for enabling communication, that include a third party wireless access point and authorization mechanism that forwards messages between an asset tracking device and a remote tracking entity based, at least in part, upon whether an outbound message contains a destination address that is on an approved list maintained by the authorization mechanism, and upon whether an inbound message contains a source address that is on an approved list maintained by the authorization mechanism.

It is to be understood that the present invention is not limited to the embodiments described above, but encompasses any and all embodiments within the scope of the subjoined Claims and their equivalents.

What is Claimed is:

1. A method of forwarding information between a device and a first entity, comprising:
receiving, at a network access point, a data packet from a source of data packets, the data packet having a header including a destination network address of the first entity;
determining whether the destination network address is a trusted destination network address by communicating the destination network address of the first entity to an authorization server; and
if the destination network address of the first entity is trusted, communicating the data packet to the destination network address of the first entity.

2. The method of claim 1, further comprising:
if the destination network address of the first entity is not trusted, communicating a rejection message to the source of the data packet.

3. The method of claim 1, wherein the first entity is a tracking entity and the device is an asset tracking device.

4. The method of claim 1, wherein communicating the destination network address of the first entity to an authorization server is done over the Internet.

5. The method of claim 1, wherein communicating the destination network address of the first entity to an authorization server is done over a local area network.

6. The method of claim 2, further comprising:
receiving, at the authorization server, a message addressed to an asset tracking device; and
determining whether the source address is on a list of approved source addresses.

7. A method of processing and communicating information at a tracking entity, comprising:
receiving, at the tracking entity, a forwarded data packet from a third party authorization server, the data packet having a header including a source identifier of a source of the data packet;
determining whether the source identifier is a trusted source identifier; and
if the source identifier is trusted, then communicating a control packet addressed to the source of the data packet to the third party authorization server.

8. The method of claim 7, further comprising:
if the source identifier is not trusted, then dropping the data packet.

9. The method of claim 7, wherein determining whether the source identifier is a trusted source identifier comprises:
communicating the source identifier to a tracking entity authorization server.

10. The method of claim 9, further comprising querying the tracking entity authorization server regarding whether the source identifier is on a list of approved source identifiers.

11. A system for enabling communication, comprising:
a device having a wireless communication module;
a network access point, operable to wirelessly communicate with the device;
an authorization entity operable to communicate with the network access point; and
a trusted network address store coupled to the authorization entity;
wherein the device is operable to communicate a data packet to the network access point, the data packet having a header including a network address of a first entity; the network access point is operable to receive the data packet communicated from the device and to communicate the data packet to the authorization entity; the authorization entity is operable to communicate with the trusted network address store to determine whether the network address of the first entity stored in the trusted network address data store; and wherein if the network address of the first entity is stored in the trusted network address data store, then the authorization entity responsive to an affirmative determination communicates the data packet to the network address of the first entity.

12. The system of claim 11, wherein the device is an RFID tag.

13. The system of claim 12, wherein the RFID tag is an active RFID tag.

14. The system of claim 11, wherein the device is an asset tracking device.

15. The system of claim 14, wherein the asset tracking device is disposed on an asset.

16. The system of claim 14, wherein the asset tracking device is disposed on a pallet of assets.

17. The system of claim 11, wherein authorization entity is coupled to the network access point by a local area network.

18. The system of claim 11, wherein the authorization entity is coupled to the network access point by the Internet.

19. The system of claim 11, wherein the authorization entity is adapted to forward a control packet to the device via the network access point.

20. The system of claim 19, wherein the device is an RFID tag adapted to receive the control packet from the network access point.
